(19) United States
(12) Patent Application Publication
(10) Pub. No.: US 2025/0351088 A1
(43) Pub. Date: Nov. 13, 2025

(54) DEFAULT POWER PARAMETERS PER TRANSMISSION AND RECEPTION POINT

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/869,224

(22) PCT Filed: Aug. 1, 2022
(86) PCT No.: PCT/CN2022/109432

§ 371 Date: Nov. 25, 2024

(51) Int. Cl. H04W 52/14; H04W 72/1268; H04W 72/231; H04W 76/20

(52) U.S. Cl. CPC H04W 52/146; H04W 72/1268; H04W 72/231; H04W 76/20

(57) ABSTRACT

Methods, systems, and devices for wireless communications at a user equipment (UE) are described. The UE may receive a first control message indicating a plurality of code points and a plurality of transmission configuration indication states. The UE may receive a second control message including a grant scheduling transmission of an uplink communication to a first transmission and reception point and an indication of a code point from the plurality of code points, the code point indicating a first transmission configuration indication state of the plurality of transmission configuration indication states for communication with the first transmission and reception point. The UE may transmit the uplink communication to the first transmission and reception point using the first transmission configuration indication state in accordance with a first set of power control parameters and the first set of power control parameters may be linked to the first transmission and reception point.

### CROSS REFERENCE

The present Application is a 371 national stage filing of International PCT Application No. PCT/CN2022/109432 by YUAN et al. entitled “DEFAULT POWER PARAMETERS PER TRANSMISSION AND RECEPTION POINT,” filed Aug. 1, 2022, which is assigned to the assignee hereof, and which is expressly incorporated by reference in its entirety herein.

### FIELD OF TECHNOLOGY

The following relates to wireless communications at a user equipment (UE), including default power parameters per transmission and reception point.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications system, a wireless device may transmit one or more messages to one or more transmission and reception points using one or more power control parameters. However, methods for such power control schemes may be improved/deficient.

### SUMMARY

The described techniques relate to improved methods, systems, devices, and apparatuses that support default power parameters per transmission and reception point. For example, a user equipment (UE) may receive a first control message indicating a plurality of code points and a plurality of transmission configuration indication states. The UE may receive a second control message including a grant scheduling transmission of an uplink communication to a first transmission and reception point and an indication of a code point from the plurality of code points, the code point indicating a first transmission configuration indication state of the plurality of transmission configuration indication states for communication with the first transmission and reception point. The UE may transmit the uplink communication to the first transmission and reception point using the first transmission configuration indication state in accordance with a first set of power control parameters of a plurality of power control parameters and the first set of power control parameters may be linked to the first transmission and reception point.

A method for wireless communications at a user equipment (UE) is described. The method may include receiving a first control message indicating a set of multiple code points and a set of multiple transmission configuration indication states, receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

An apparatus for wireless communication is described. The apparatus may include a memory, a transceiver, and at least one processor of a user equipment, the at least one processor coupled with the memory and the transceiver. The at least one processor may be configured to cause the apparatus to receive a first control message indicating a set of multiple code points and a set of multiple transmission configuration indication states, receive a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and transmit the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

Another apparatus for wireless communications at a UE is described. The apparatus may include means for receiving a first control message indicating a set of multiple code points and a set of multiple transmission configuration indication states, means for receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and means for transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

A non-transitory computer-readable medium storing code for wireless communications at a UE is described. The code may include instructions executable by a processor to receive a first control message indicating a set of multiple code points and a set of multiple transmission configuration indication states, receive a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and transmit the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

Some examples of the method, apparatuses, and non-transitory computer-readable medium described herein may further include operations, features, means, or instructions for receiving the control signaling indicating a transmission configuration indication state list corresponding to multiple transmission and reception point operation and the set of multiple power control parameters, where the transmission configuration indication state list includes the set of multiple transmission configuration indication states.

Some examples of the method, apparatuses, and non-transitory computer-readable medium described herein may further include operations, features, means, or instructions for processing the control signaling, the first control message, or the second control message that indicates the linkage between the first transmission and reception point and the first set of power control parameters.

Some examples of the method, apparatuses, and non-transitory computer-readable medium described herein may further include operations, features, means, or instructions for processing the control signaling that indicates the linkage between an identifier of the first set of power control parameters and the first transmission configuration indication state.

In some examples of the method, apparatuses, and non-transitory computer-readable medium described herein, the control signaling may be radio resource control signaling.

Some examples of the method, apparatuses, and non-transitory computer-readable medium described herein may further include operations, features, means, or instructions for processing the first control message that indicates the linkage between an identifier of the first set of power control parameters and the first transmission configuration indication state.

In some examples of the method, apparatuses, and non-transitory computer-readable medium described herein, the first control message includes a medium access control control element.

Some examples of the method, apparatuses, and non-transitory computer-readable medium described herein may further include operations, features, means, or instructions for processing the second control message that indicates the linkage between an identifier of the first set of power control parameters and the first transmission configuration indication state.

In some examples of the method, apparatuses, and non-transitory computer-readable medium described herein, the second control message includes downlink control information.

Some examples of the method, apparatuses, and non-transitory computer-readable medium described herein may further include operations, features, means, or instructions for identifying that the first transmission configuration indication state and the first set of power control parameters may be both associated with a communication parameter identifier.

In some examples of the method, apparatuses, and non-transitory computer-readable medium described herein, the communication parameter identifier includes an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

Some examples of the method, apparatuses, and non-transitory computer-readable medium described herein may further include operations, features, means, or instructions for matching an index associated with the first transmission configuration indication state and an index associated with the first set of power control parameters where both indices include a common value.

In some examples of the method, apparatuses, and non-transitory computer-readable medium described herein, the set of multiple power control parameters corresponds to a traffic type associated with the uplink communication.

A method for wireless communications at a network entity is described. The method may include transmitting a first control message indicating a set of multiple code points and a set of multiple transmission configuration indication states, transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

An apparatus for wireless communication is described. The apparatus may include a memory, a transceiver, and at least one processor of a network entity, the at least one processor coupled with the memory and the transceiver. The at least one processor may be configured to cause the apparatus to transmit a first control message indicating a set of multiple code points and a set of multiple transmission configuration indication states, transmit a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and receive the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

Another apparatus for wireless communications at a network entity is described. The apparatus may include means for transmitting a first control message indicating a set of multiple code points and a set of multiple transmission configuration indication states, means for transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and means for receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

A non-transitory computer-readable medium storing code for wireless communications at a network entity is described. The code may include instructions executable by a processor to transmit a first control message indicating a set of multiple code points and a set of multiple transmission configuration indication states, transmit a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point, and receive the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

Some examples of the method, apparatuses, and non-transitory computer-readable medium described herein may further include operations, features, means, or instructions for transmitting the control signaling indicating a transmission configuration indication state list corresponding to multiple transmission and reception point operation and the set of multiple power control parameters, where the transmission configuration indication state list includes the set of multiple transmission configuration indication states.

Some examples of the method, apparatuses, and non-transitory computer-readable medium described herein may further include operations, features, means, or instructions for transmitting the control signaling, the first control message, or the second control message that indicates the linkage between the first transmission and reception point and the first set of power control parameters.

Some examples of the method, apparatuses, and non-transitory computer-readable medium described herein may further include operations, features, means, or instructions for transmitting the control signaling that indicates the linkage between an identifier of the first set of power control parameters and the first transmission configuration indication state.

In some examples of the method, apparatuses, and non-transitory computer-readable medium described herein, the control signaling may be radio resource control signaling.

Some examples of the method, apparatuses, and non-transitory computer-readable medium described herein may further include operations, features, means, or instructions for transmitting the first control message that indicates the linkage between an identifier of the first set of power control parameters and the first transmission configuration indication state.

In some examples of the method, apparatuses, and non-transitory computer-readable medium described herein, the first control message includes a medium access control control element.

Some examples of the method, apparatuses, and non-transitory computer-readable medium described herein may further include operations, features, means, or instructions for transmitting the second control message that indicates the linkage between an identifier of the first set of power control parameters and the first transmission configuration indication state.

In some examples of the method, apparatuses, and non-transitory computer-readable medium described herein, the second control message includes downlink control information.

In some examples of the method, apparatuses, and non-transitory computer-readable medium described herein, the first set of power control parameters and the first transmission configuration indication state may be both associated with a communication parameter identifier.

In some examples of the method, apparatuses, and non-transitory computer-readable medium described herein, the communication parameter identifier includes an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

In some examples of the method, apparatuses, and non-transitory computer-readable medium described herein, an index associated with the first transmission configuration indication state oand an index associated with the first set of power control parameters both include a common value.

Some examples of the method, apparatuses, and non-transitory computer-readable medium described herein may further include operations, features, means, or instructions for selecting the set of multiple power control parameters based on a traffic type associated with the uplink communication.

### BRIEF DESCRIPTION OF THE DRAWINGS

FIG. 1 illustrates an example of a wireless communications system that supports default power parameters per transmission and reception point in accordance with one or more aspects of the present disclosure.

FIG. 2 illustrates an example of a wireless communication system that supports default power parameters per transmission and reception point in accordance with one or more aspects of the present disclosure.

FIG. 3 illustrates an example of a process flow that supports default power parameters per transmission and reception point in accordance with one or more aspects of the present disclosure.

FIG. 4 illustrates an example of a process flow that supports default power parameters per transmission and reception point in accordance with one or more aspects of the present disclosure.

FIGS. 5 and 6 show block diagrams of devices that support default power parameters per transmission and reception point in accordance with one or more aspects of the present disclosure.

FIG. 7 shows a block diagram of a communications manager that supports default power parameters per transmission and reception point in accordance with one or more aspects of the present disclosure.

FIG. 8 shows a diagram of a system including a device that supports default power parameters per transmission and reception point in accordance with one or more aspects of the present disclosure.

FIGS. 9 and 10 show block diagrams of devices that support default power parameters per transmission and reception point in accordance with one or more aspects of the present disclosure.

FIG. 11 shows a block diagram of a communications manager that supports default power parameters per transmission and reception point in accordance with one or more aspects of the present disclosure.

FIG. 12 shows a diagram of a system including a device that supports default power parameters per transmission and reception point in accordance with one or more aspects of the present disclosure.

FIGS. 13 and 14 show flowcharts illustrating methods that support default power parameters per transmission and reception point in accordance with one or more aspects of the present disclosure.

### DETAILED DESCRIPTION

In the course of wireless communications, a user equipment (UE) may communicate with multiple transmission and reception points (TRPs). The multiple TRPs may each be associated with a single transmission configuration indication (TCI) state, also referred to as a unified TCI state, and the UE may receive an indication of such a unified TCI state. In some cases, such a TCI state may designate a set of power control parameters that the UE is to use for communications with a TRP. However, in some cases, such a unified TCI state associated with a TRP may not include or be associated with a set of power control parameters for the UE to use for uplink communication with the TRP.

A default set of power control parameters corresponding to such a TRP may be specified or indicated to the UE, and the UE may use the default power control parameters for beamformed uplink transmission in multi-TRP operation. For example, different types of transmissions (e.g., physical uplink shared channel (PUSCH), physical uplink control channel (PUCCH), sounding reference signal (SRS), or other transmissions) may each have a default set of power control parameters (e.g., PL-RS, P0, alpha, a closed loop index, other parameters, or any combination thereof). For a given channel or reference signal type, the UE may be provided with multiple sets of power control parameters that may correspond to the TRP (e.g., based on or associated with a TRP identifier). In some cases, different sets of power control parameters may be introduced for different traffic types (e.g., eMBB or URLLC) for a given channel or reference signal type. Further, the UE may receive signaling that may indicate (e.g., in RRC, medium access control-control element (MAC-CE), downlink control information (DCI), or other signaling) which of the multiple default sets are to be used for communications. In some case, which of the multiple default sets to be applied can be dynamically indicated in DCI scheduling or activating uplink transmissions, or configured for semi-persistent uplink transmissions, or any combination thereof. Such indications may include an indication of a linkage between the TRP and a particular set of power control parameters from the different sets of power control parameters that the UE is to use as the default set of power control parameters. Such an indication may be defined or communicated to the UE through a linkage between the TCI state and the power control parameter set that is to be used in various ways (e.g., explicit indication, implicit indication through association with a common parameter, such as a TRP ID or other parameter, common index values, other approaches as described herein, or any combination thereof). In this way, in the absence of explicitly provided power control parameters for a TCI state associated with a TRP in multiple TRP (mTRP) operation, the UE may use the default set of power control parameters for communications with the TRP.

Aspects of the disclosure are initially described in the context of wireless communications systems. Aspects of the disclosure are then described in the context of wireless communications systems and process flows. Aspects of the disclosure are further illustrated by and described with reference to apparatus diagrams, system diagrams, and flowcharts that relate to default power parameters per transmission and reception point.

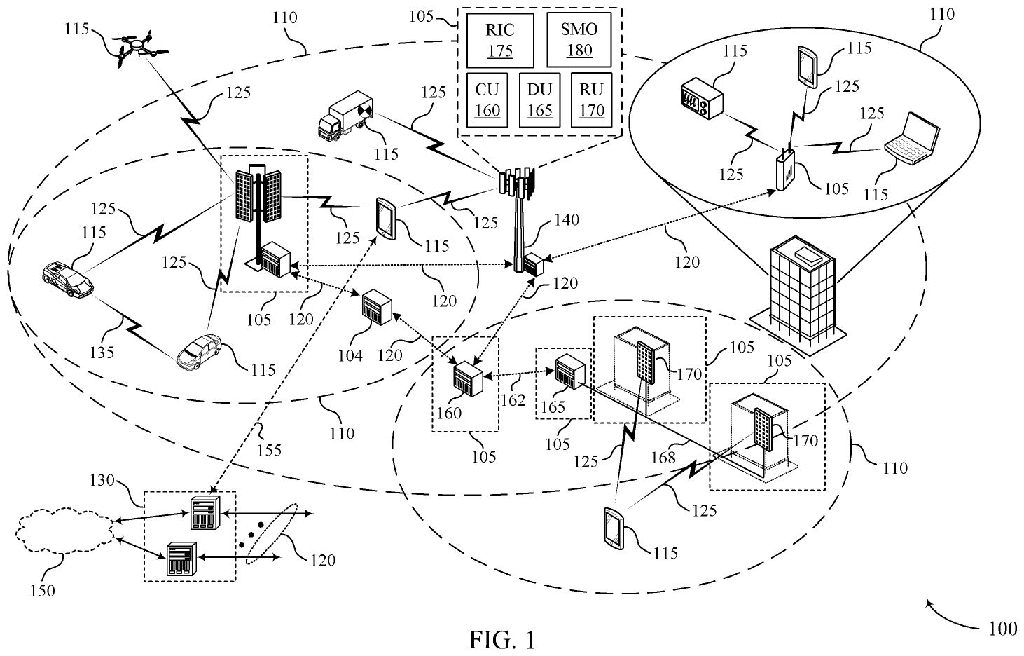

FIG. 1 illustrates an example of a wireless communications system 100 that supports default power parameters per transmission and reception point in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support default power parameters per transmission and reception point as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some implementations, a UE 115 and a network entity 105 may support one or more signaling- or configuration-based mechanisms according to which the UE 115 and the network entity 105 may operate with one or more default sets of power control parameters in mTRP operations. For example, the UE 115 may communicate with multiple TRPs and the UE 115 may be provided with multiple default sets of power control parameters (e.g., for one or more given channels or reference signal types) that may correspond to the TRP (e.g., based on or associated with a TRP identifier). The UE 115 may determine or select the default set of power control parameters based on a linkage between a TCI state communicated or indicated to the UE 115 and the default set of power control parameters and this linkage may be communicated or indicated in various ways (e.g., explicit indication, implicit indication through association with a common parameter such as a TRP ID or other parameter, common index values, other approaches as described herein, or any combination thereof).

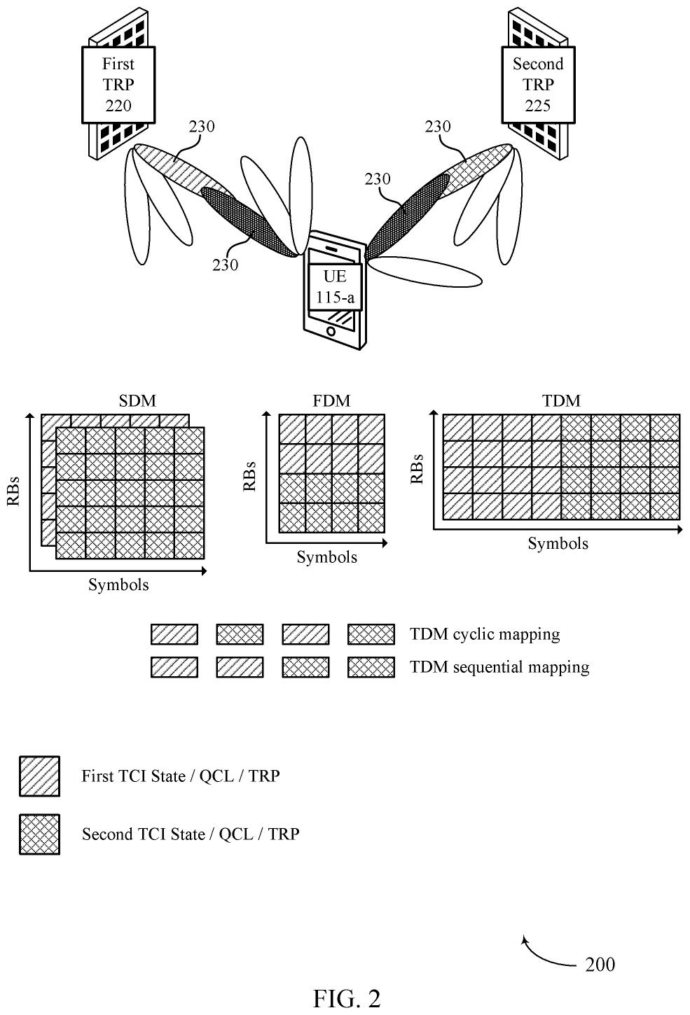

FIG. 2 illustrates an example of a wireless communication system 200 that supports default power parameters per transmission and reception point in accordance with one or more aspects of the present disclosure. The wireless communication system 200 may include UE 115-a that may be an example of UE 115 discussed in relation to FIG. 1. The wireless communication system 200 may include a first TRP 220 and a second TRP 225.

In the course of wireless communications, the UE 115-a may communicate with one or more TRPs, such as the first TRP 220 and the second TRP 225. The UE 115-a may communicate with the first TRP 220 and the second TRP 225 via communication beams 230. The UE 115-a, the first TRP 220, and the second TRP 225 may employ one or more communication beams 230 for communication with wireless devices and may select one or more communication beams 230 for communication with a particular device.

To communicate with the first TRP 220 and the second TRP 225, the UE 115-a may employ one or more strategies for communicating with both the first TRP 220 and the second TRP 225. For example, the UE 115-a may employ the use of spatial domain multiplexing (SDM). In SDM, the UE 115-a may use different communication beams 230 to communicate with the first TRP 220 and the second TRP 225, thereby separating the communications spatially. The UE 115-a may employ the use of frequency domain multiplexing (FDM), in which different frequency resources may be used for communication with the first TRP 220 and the second TRP 225. The UE 115-a may employ the use of time domain multiplexing (TDM) in which different time resources may be used for communication with the first TRP 220 and the second TRP 225. In some examples involving TDM, the UE 115-a may engage in cyclic mapping (e.g., in which the UE 115-a may communicate over time resources that are assigned to multiple TRPs in a cyclic manner) or sequential mapping (e.g., in which the UE 115-a may communicate over time resources in a sequential manner).

As the first TRP 220 and the second TRP 225 may be located in different places and the UE 115-a may be mobile, channel conditions between the UE 115-a and the first TRP 220 may be different than channel conditions between the UE 115-a and the second TRP 225. For example, different obstacles, noise, or interference may be present. As such the UE 115-a may employ power control parameters to adjust a transmission power to use with communications for the first TRP 220 and the second TRP 225. In some cases, such power control parameters may be provided to the UE 115-a (e.g., from a network entity). However, in some cases, a selected uplink TCI state associated with a TRP ID may not indicate which set of power control parameters the UE 115-a is to use for one or more uplink transmissions to the TRP corresponding to the TRP ID, and some approaches to wireless communications may not indicates any default power control parameters for the UE 115-a to use in such cases.

A default set of power control parameters corresponding to a TRP (e.g., the first TRP 220, the second TRP 225, or both) may be specified or indicated to the UE 115-a and the UE may use the default power control parameters for beamformed uplink transmission in multi-TRP operation. For example, the UE 115-a may receive a first control message (e.g., RRC, MAC-CE, DCI, or other control signaling) that may include one or more codepoints and each codepoint may be mapped with one or more TCI states. The UE 115-a may receive a second control message (e.g., RRC, MAC-CE, DCI, or other control signaling) that may include an indication of a codepoint that may match with one of the codepoints provided in the first control message, thereby indicating a first TCI state and/or the second TCI state that the UE 115-a is to use for communication with the first TRP 220 and/or the second TRP 225. The UE 115-a may also receive a third control message (e.g., RRC, MAC-CE, DCI, or other control signaling) include a grant for an uplink transmission. If the uplink transmission is scheduled associated with the first TRP 220, the UE 115-a may then transmit an uplink communication to the first TRP 220 using the first TCI and may do so using a first set of power control parameters. If the uplink transmission is scheduled associated with the second TRP 225, the UE 115-a may then transmit an uplink communication to the second TRP 225 using the second TCI and may do so using a second set of power control parameters. If the uplink transmission is scheduled associated with both the first TRP 220 and the second TRP 225, the UE 115-a may then transmit an uplink communication to both the first TRP 220 and the second TRP 225 using the first TCI and the second TCI, and may do so using a first set and a second set of power control parameters, respectively. The UE 115-a may identify, determine, or select the first set of power control parameters based on a linkage, association, or mapping between the first TRP 220 and the first set of power control parameters. Similarly, the UE 115-a may identify, determine, or select the second set of power control parameters based on a linkage, association, or mapping between the second TRP 225 and the second set of power control parameters. In this way, the UE 115-a may be provided with default sets of power control parameters for communications with multiple TRPs. In some aspects, different TRPs may be associated with different other identifiers. For example, different TRP may correspond to different CORESET pool indexes, different close loop indexes, different TCI or TCI group IDs, or different SRS resource set IDs. A TRP ID associated with a channel or reference signal may be determined by the other identifiers associated with a channel or reference signal.

In some examples, the UE 115-a, one or more network entities, the first TRP 220, the second TRP 225, or any combination thereof may perform operations associated with one or more unified TCIs. Such unified TCIs may be of different types, sometimes designated as Types 1-6. For example, a type 1 unified TCI may include a joint downlink and uplink common TCI state that may indicate a common beam for at least one downlink channel, reference signal, or both as well as at least one uplink channel, reference signal, or both. A type 2 unified TCI may include a separate downlink common TCI state to indicate a common beam for more than one downlink channel, reference signal, or both. A type 3 unified TCI may include a separate uplink common TCI state to indicate a common beam for more than one uplink channel, reference signal, or both. A type 4 unified TCI may include a separate downlink single channel or reference signal TCI state (or both) to indicate a beam for a single downlink channel, reference signal, or both. A type 5 unified TCI may include a separate uplink single channel or reference signal TCI state (or both) to indicate a beam for a single uplink channel, reference signal, or both. A type 6 unified TCI may include uplink spatial relation info (SRI) to indicate a beam for a single uplink channel/reference signal. Any (single or multiple) or all of these unified TCI states may be employed in relation to the approaches described herein. In some examples of the subject matter described herein, an uplink applicable TCI may include uplink and joint TCI.

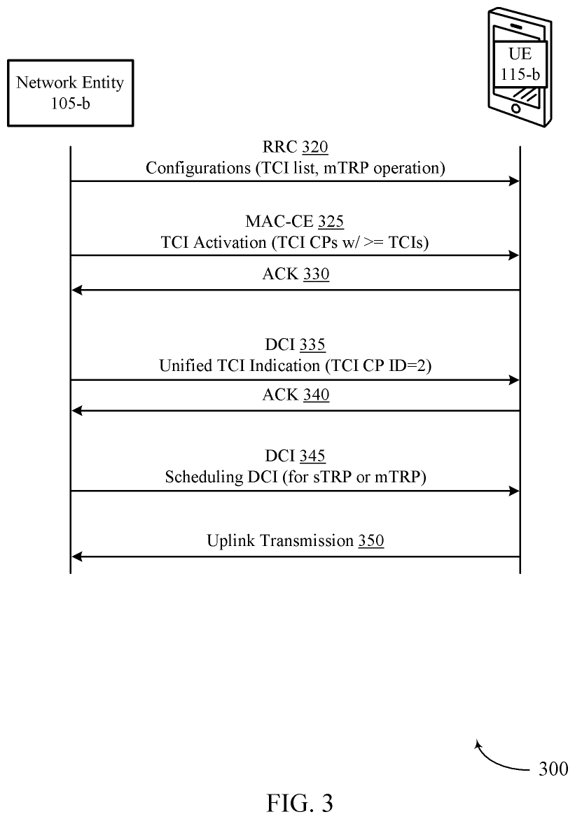

FIG. 3 illustrates an example of a process flow 300 that supports default power parameters per transmission and reception point in accordance with one or more aspects of the present disclosure. The process flow 300 may include or involve a network entity 105-b and a UE 115-b engaging in various procedures for wireless communications. The process flow 300 may describe subject matter relative to unified TCI indications as it relates to providing default power parameters to the UE 115-b for communications with one or more TRPs.

The UE 115-b may receive an RRC 320 (e.g., from the network entity 105-b). The RRC 320 may include one or more configurations that may be associated with a TCI list, mTRP operation, or both.). For example, the UE 115-a may receive RRC 320 which may contain a list of TCIs, one or more of which may be selected for communications with one or more TRPs. Further, such TCIs of the TCI list may be used by the UE 115-b to select, determine, or identify a set of default power parameters for communicating with a TRP.

The UE 115-b may receive MAC-CE 325 (e.g., from the network entity 105-b). The MAC-CE 325 may include a TCI activation or indication that may indicate one or more codepoints that may be associated with some or all of the TCI states of the TCI state list that was included in the RRC 320. In some examples, the UE 115-b may transmit the acknowledge (ACK) 330 in response to receiving the MAC-CE 325.

The UE 115-b may receive DCI 335 (e.g., from the network entity 105-b). The DCI 335 may include a unified TCI indication that may indicate a codepoint (e.g., of the one or more codepoints that were included in the MAC-CE 325). The codepoint may be mapped with one or more TCI states or TCI state identifiers, and the UE 115-b may determine, select, or identify that the UE 115-b is to use a TCI state mapped in the codepoint for communications with a TRP. Additionally, or alternatively, such a TCI state may be used by the UE 115-b to select, determine, or identify at least a set of power parameters for communication with a TRP. For example, the UE 115-b may determine or identify that the selected TCI state is associated with one or more sets of default power parameters that may also be associated with the TRP with which the UE 115-a may be communicating. In some examples, the UE 115-b may transmit the ACK 340 to acknowledge receipt of the DCI 335. In some examples, the UE 115-b may receive the DCI 345 or other DCI may include scheduling that may schedule one or more transmissions of a channel or a reference signal (e.g., uplink transmissions) associated with either single TRP (sTRP) or mTRP operation. Such one or more transmissions may be transmissions that are to be transmitted using the default set of power parameters that is determined, identified, selected, or obtained according to subject matter described herein.

In some examples, the UE 115-b may transmit one or more uplink transmissions 350 (e.g., that may have been scheduled by the DCI 335 or one or more other DCIs). In some examples, such an uplink transmission 350 may be transmitted using the default set of power parameters that is determined, identified, selected, or obtained according to the subject matter described herein.

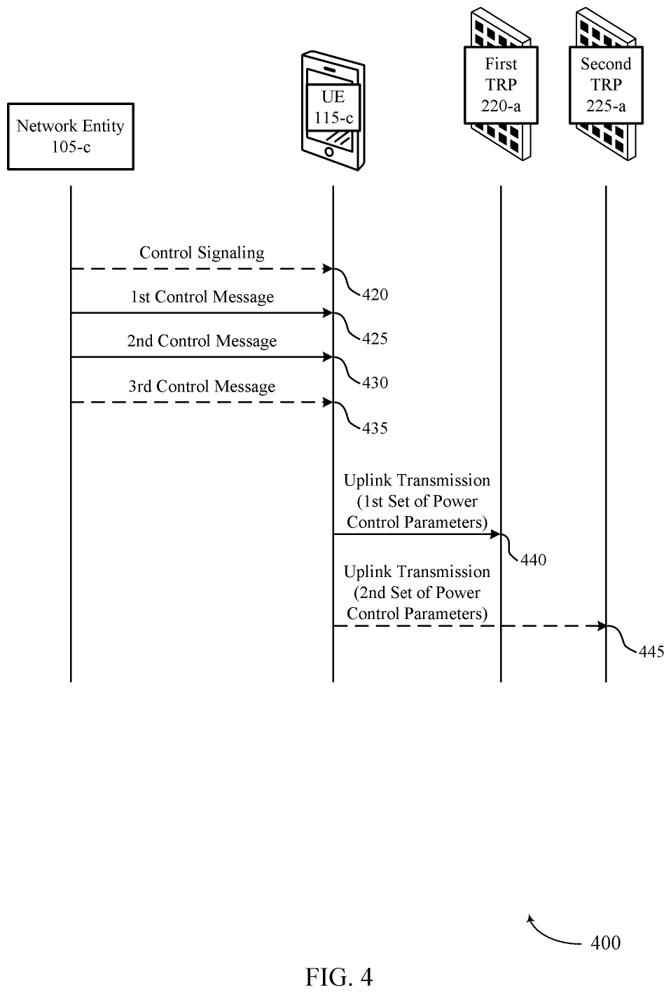

FIG. 4 illustrates an example of a process flow 400 that supports default power parameters per transmission and reception point in accordance with one or more aspects of the present disclosure. The process flow 400 may implement various aspects of the present disclosure described with reference to FIGS. 1-3. The process flow 400 may include network entity 105-c, UE 115-c, first TRP 220-a, and first TRP 220, which may be examples of similarly named elements as described with reference to FIGS. 1-3.

In the following description of the process flow 400, the operations between the network entity 105-c, UE 115-c, first TRP 220-a, and first TRP 220 may be performed in different orders or at different times. Some operations may also be left out of the process flow 400, or other operations may be added. Although the network entity 105-c, UE 115-c, first TRP 220-a, and first TRP 220 are shown performing the operations of the process flow 400, some aspects of some operations may also be performed by other elements of the process flow 400 or by elements that are not depicted in the process flow, or any combination thereof.

At 420, the UE 115-c may receive control signaling indicating a transmission configuration indication state list corresponding to multiple transmission and reception point operation and the plurality sets of power control parameters and the transmission configuration indication state list may include the plurality of transmission configuration indication states.

At 425, the UE 115-c may receive a first control message indicating a plurality of code points and a plurality of transmission configuration indication states to each code points.

At 430, the UE 115-c may receive a second control message including an indication of a code point from the plurality of code points. In some examples, the code point may indicate a first transmission configuration indication state of the plurality of transmission configuration indication states for communication with the first transmission and reception point (e.g., first TRP 220-a). In some examples, the code point may indicate a second transmission configuration indication state of the plurality of transmission configuration indication states for communication with the second transmission and reception point (e.g., second TRP 225-a). In some examples, the code point may indicate first and second transmission configuration indication states of the plurality of transmission configuration indication states for communication with the first and the second transmission and reception point (e.g., first TRP 220-a, second TRP 225-a), respectively.

In some examples in which the UE 115-c is provided with multiple sets of power control parameters corresponding to a same TRP or TRP identifier, the second control message (e.g., which may be a DCI) may dynamically indicate which of such multiple sets may be applied. The second control message may schedule or activate an uplink transmission or may be configured for persistent or semi-persistent uplink transmissions.

At 435, the UE 115-c may receive a third control message comprising a grant scheduling transmission of an uplink communication. In some examples, the third control message may schedule the transmission to the first transmission and reception point 220-a. In some examples, the third control message may schedule the transmission to the second transmission and reception point 225-a. In some examples, the third control message may schedule the transmission to the first transmission and reception point 220-a and to the second transmission and reception point 225-a. In some examples, the network entity 105-c may cause at least one of TRPs 220-a, 225-a, or both, to send one or more of the transmissions described at 420, 425, 430, and 435, or may cause a different device to send one or more of the transmissions. The UE 115-c may determine or select a TCI for the uplink transmission to a transmission and reception point based on the second and/or the third control messages.

At 440, the UE 115-c may transmit the uplink communication to the first transmission and reception point (e.g., first TRP 220-a) using the first transmission configuration indication state in accordance with a first set of power control parameters of a plurality of power control parameters, and at 445, the UE 115-c may transmit the uplink communication to the second transmission and reception point (e.g., second TRP 225-a) using the second transmission configuration indication state in accordance with a second set of power control parameters of a plurality of power control parameters. In some examples, the first set of power control parameters may be linked to the first transmission and reception point (e.g., first TRP 220-a), and the second set of power control parameters may be linked to the second transmission and reception point (e.g., second TRP 225-a). If the uplink communication at 440 or 445 is preconfigured periodical or semi-persistent transmission, the UE 115-c may not receive a third control message.

In some examples, the set of power control parameters may be associated with a signal or transmission type (e.g., a PUSCH transmission, a PUCCH transmission, an SRS transmission, other transmissions, or any combination thereof) for a TRP. For example, there may be one set of power control parameters associated with a PUSCH transmission for a TRP, and another set of power control parameters associated with a PUCCH transmission for the TRP. The set of power control parameters (or other sets of power control parameters) may include parameters such as a path loss reference signal identifier that may indicate a path loss reference signal, P₀ that may be an initial power control parameter (e.g., a target signal-to-interference plus noise ratio (SINR) for a power control), a that may be a path loss compensation factor, and closed loop power control parameters. In some example, for a given uplink channel or reference signal type, multiple default sets of power control parameters corresponding to the same TRP or TRP identifier may be introduced. In some examples, such multiple default sets of power control parameters may be introduced for different uplink traffic types (e.g., eMMB, URLLC, or other traffic types) for a given uplink channel or reference signal type of a TRP.

In some aspects, the UE 115-c may process the control signaling, the first control message, or the second control message that indicates the linkage between the transmission and reception point and the set of power control parameters of the plurality of power control parameters. In some examples, the UE 115-c may process the control signaling that indicates the linkage between an identifier of the set of power control parameters of the plurality of power control parameters and the transmission configuration indication state of the plurality of transmission configuration indication states. In some examples, the control signaling may be radio resource control signaling.

In some examples, the UE 115-c may process the first control message that indicates the linkage between an identifier of the first set of power control parameters of the plurality of power control parameters and the first transmission configuration indication state of the plurality of transmission configuration indication states. In some examples, the first control message may include a medium access control control element.

In some examples, the UE 115-c may process the second control message that indicates the linkage between an identifier of the first set of power control parameters of the plurality of power control parameters and the first transmission configuration indication state of the plurality of transmission configuration indication states. In some examples, the second control message may include downlink control information.

In some examples, the UE 115-c may identify that the first transmission configuration indication state and the first set of power control parameters of the plurality of power control parameters are both associated with a communication parameter identifier. In some examples, the communication parameter identifier may include an identifier associated with the first transmission and reception point (e.g., first TRP 220-a), a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

In some examples, the UE 115-c may match an index associated with the first transmission configuration indication state of the plurality of transmission configuration indication states and an index associated with the first set of power control parameters of the plurality of power control parameters wherein both indices comprise a common value.

In some examples, a set of power control parameters may correspond to a traffic type associated with the uplink communication. For example, a traffic type may be a eMMB traffic type, a URLLC traffic type, or another traffic type. For example, there may be one sets of power control parameters associated with a eMMB transmission for a TRP, and another set of power control parameters associated with a URLLC transmission for the TRP.

As described herein, the association of one or more default power control parameter sets with a uplink applicable TCI selected for a uplink transmission may be established in various ways. In some examples, the linked default set of power control parameters or the TCI may be indicated in a configuration of the other. For example, an identifier of a linked default power control parameter set may be indicated or configured per TCI state identifier (e.g., as indicated in a TCI state information element included in DCI, MAC-CE, RRC signaling, or the like). Additionally, or alternatively, an identifier of a linked TCI may be indicated or configured per default set of power control parameters (e.g., as indicated in a TCI state information element included in DCI, MAC-CE, RRC signaling, or the like).

In some examples, the linkage between the default set of power parameters and the TCI may be dynamically indicated in control signaling or message (e.g., MAC-CE or DCI). For example, the linkage may be indicated in the control signaling, the 1st control message, the 2nd control message, the 3rd control message, or any combination thereof. For example, an activation MAC-CE (of which the first control message may be an example) may indicate an identifier of a default set of power control parameters that the UE 115-c is to use for an uplink transmission. In an example, an activation control message (e.g., a MAC-CE) may indicate one or more default power control parameter set identifiers per activated TCI state.

In some examples, the linkage between the default set of power parameters and the TCI may be indicated by an explicit or implicit TRP identifier. For example, one or more, or each, selected unified TCIs or TCI states may be mapped to an intended TRP identifier (e.g., an explicit TRP identifier), and each default set of power control parameters may also be mapped to an intended TRP identifier (e.g., an explicit TRP identifier). Additionally, or alternatively, the one or more selected unified TCIs or TCI states and each default set of power control parameters may be mapped to another parameter (e.g., which may be an implicit TRP identifier). Examples of such other parameters may include CORESETPoolIndex, a TCI/beam group identifier, a channel, reference signal/resource group identifier, an SRI field order index, an SRS resource set identifier/order index, a default power control parameter set identifier, or any combination thereof. For example, an uplink applicable TCI state or default power control parameter set may be associated with a first or second SRS resource set that may be mapped to a TRP identifier of 1 or 2.

In some examples, the linkage between the default set of power parameters and the TCI may be implicitly determined by an order index of the TCI and the default set of power parameters. For example, the first-indexed TCI in a TCI codepoint may map to a first-indexed set of power control parameters, and the second-indexed TCI in a TCI codepoint may map to a second-indexed set of power control parameters, etc.

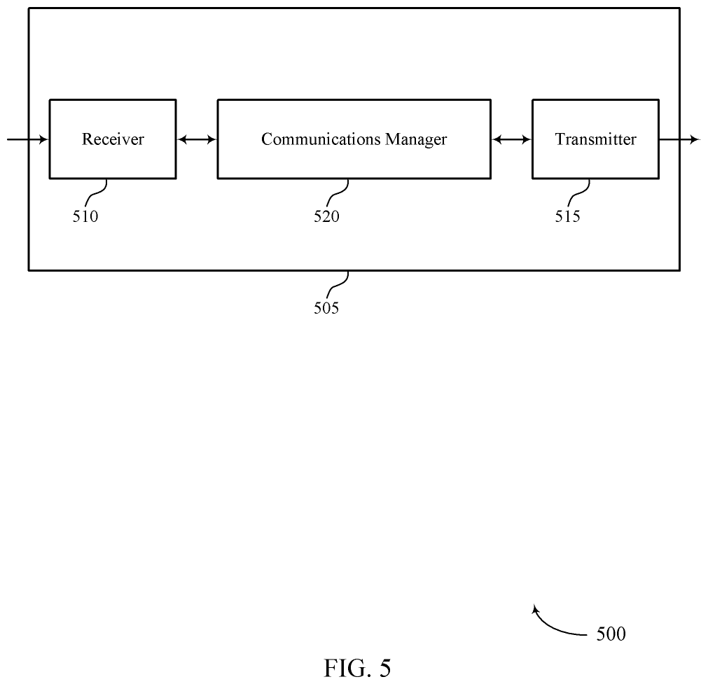

FIG. 5 shows a block diagram 500 of a device 505 that supports default power parameters per transmission and reception point in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to default power parameters per transmission and reception point). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to default power parameters per transmission and reception point). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of default power parameters per transmission and reception point as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a first control message indicating a set of multiple code points and a set of multiple transmission configuration indication states. The communications manager 520 may be configured as or otherwise support a means for receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The communications manager 520 may be configured as or otherwise support a means for transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, more efficient utilization of communication resources, or any combination thereof.

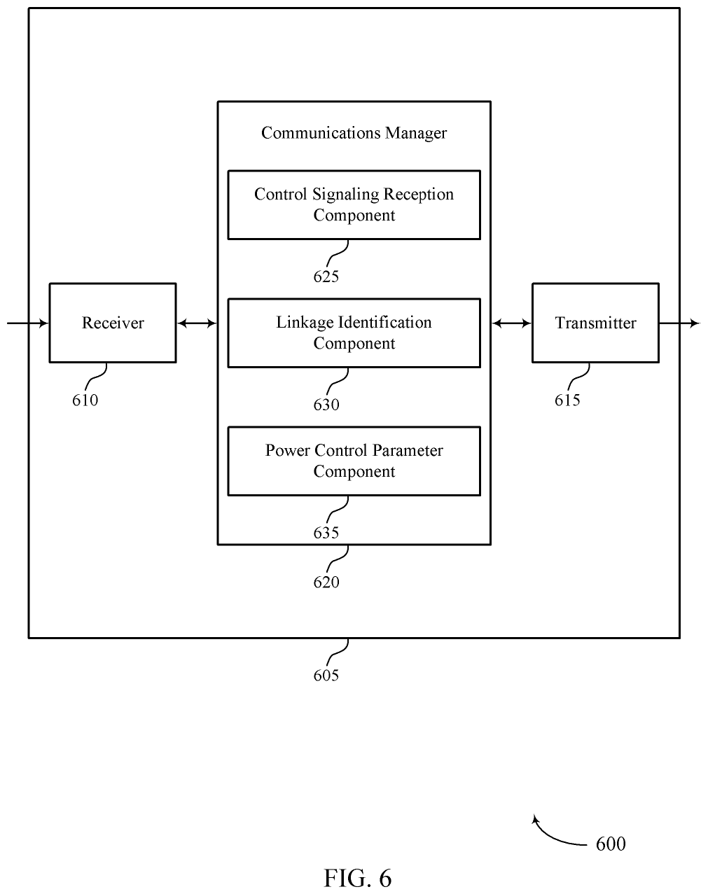

FIG. 6 shows a block diagram 600 of a device 605 that supports default power parameters per transmission and reception point in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to default power parameters per transmission and reception point). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to default power parameters per transmission and reception point). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of default power parameters per transmission and reception point as described herein. For example, the communications manager 620 may include a control signaling reception component 625 a power control parameter component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The control signaling reception component 625 may be configured as or otherwise support a means for receiving a first control message indicating a set of multiple code points and a set of multiple transmission configuration indication states. The control signaling reception component 625 may be configured as or otherwise support a means for receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The power control parameter component 630 may be configured as or otherwise support a means for transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

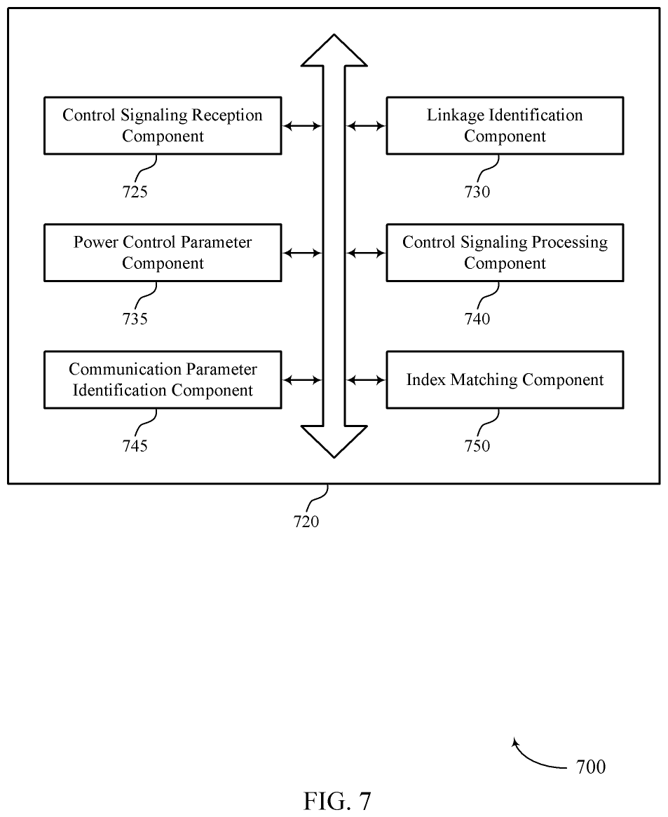

FIG. 7 shows a block diagram 700 of a communications manager 720 that supports default power parameters per transmission and reception point in accordance with one or more aspects of the present disclosure. The communications manager 720 may be an example of aspects of a communications manager 520, a communications manager 620, or both, as described herein. The communications manager 720, or various components thereof, may be an example of means for performing various aspects of default power parameters per transmission and reception point as described herein. For example, the communications manager 720 may include a control signaling reception component 725, a power control parameter component 730, a control signaling processing component 735, a communication parameter identification component 740, an index matching component 745, or any combination thereof. Each of these components may communicate, directly or indirectly, with one another (e.g., via one or more buses).

The communications manager 720 may support wireless communications at a UE in accordance with examples as disclosed herein. The control signaling reception component 725 may be configured as or otherwise support a means for receiving a first control message indicating a set of multiple code points and a set of multiple transmission configuration indication states. In some examples, the control signaling reception component 725 may be configured as or otherwise support a means for receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The power control parameter component 730 may be configured as or otherwise support a means for transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

In some examples, the control signaling reception component 725 may be configured as or otherwise support a means for receiving control signaling indicating a transmission configuration indication state list corresponding to multiple transmission and reception point operation and the set of multiple power control parameters, where the transmission configuration indication state list includes the set of multiple transmission configuration indication states.

In some examples, to support identifying the linkage, the control signaling processing component 735 may be configured as or otherwise support a means for processing the control signaling, the first control message, or the second control message that indicates the linkage between the first transmission and reception point and the first set of power control parameters.

In some examples, to support identifying the linkage, the control signaling processing component 735 may be configured as or otherwise support a means for processing the control signaling that indicates the linkage between an identifier of the first set of power control parameters and the first transmission configuration indication state.

In some examples, the control signaling is radio resource control signaling.

In some examples, to support identifying the linkage, the control signaling processing component 735 may be configured as or otherwise support a means for processing the first control message that indicates the linkage between an identifier of the first set of power control parameters and the first transmission configuration indication state.

In some examples, the first control message includes a medium access control control element.

In some examples, to support identifying the linkage, the control signaling processing component 735 may be configured as or otherwise support a means for processing the second control message that indicates the linkage between an identifier of the first set of power control parameters and the first transmission configuration indication state.

In some examples, the second control message includes downlink control information.

In some examples, to support identifying the linkage, the communication parameter identification component 740 may be configured as or otherwise support a means for identifying that the first transmission configuration indication state and the first set of power control parameters are both associated with a communication parameter identifier.

In some examples, the communication parameter identifier includes an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

In some examples, to support identifying the linkage, the index matching component 745 may be configured as or otherwise support a means for matching an index associated with the first transmission configuration indication state and an index associated with the first set of power control parameters where both indices include a common value.

In some examples, the set of multiple power control parameters correspond to a traffic type associated with the uplink communication.

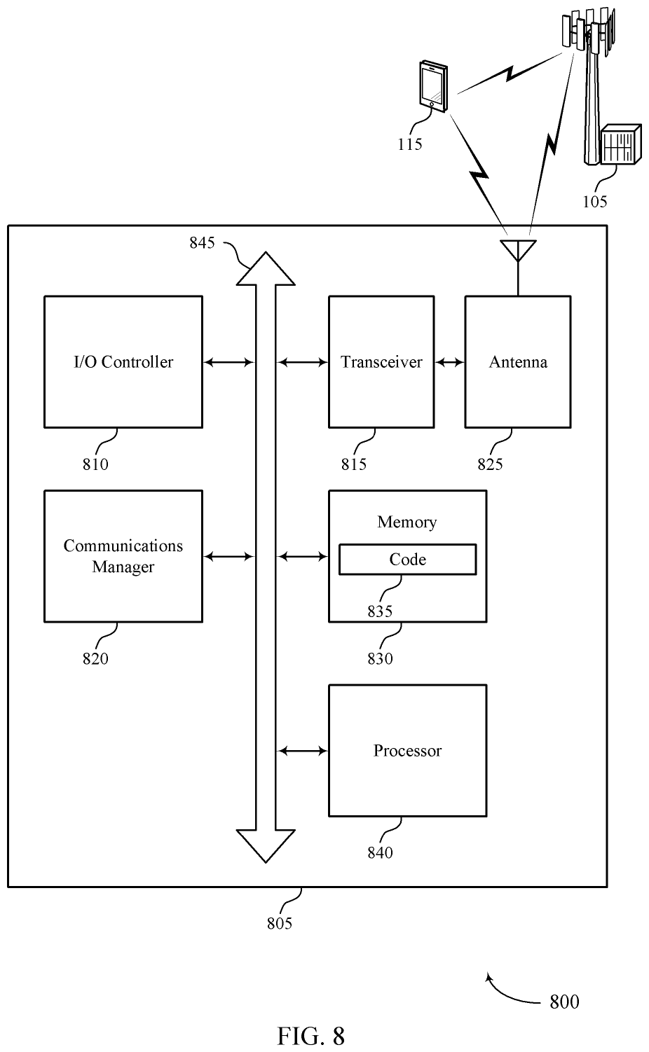

FIG. 8 shows a diagram of a system 800 including a device 805 that supports default power parameters per transmission and reception point in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting default power parameters per transmission and reception point). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first control message indicating a set of multiple code points and a set of multiple transmission configuration indication states. The communications manager 820 may be configured as or otherwise support a means for receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The communications manager 820 may be configured as or otherwise support a means for transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of default power parameters per transmission and reception point as described herein, or the processor 840 and the memory 830 may be otherwise configured to perform or support such operations.

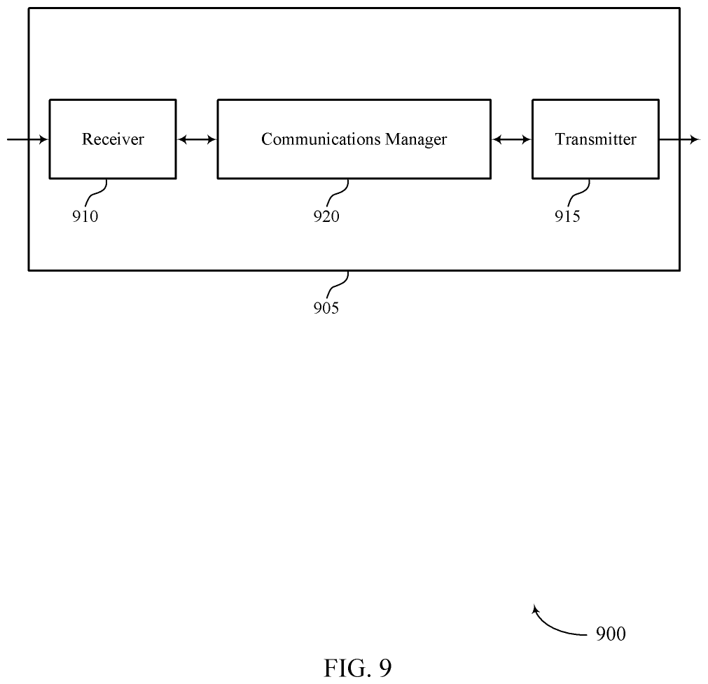

FIG. 9 shows a block diagram 900 of a device 905 that supports default power parameters per transmission and reception point in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of default power parameters per transmission and reception point as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a first control message indicating a set of multiple code points and a set of multiple transmission configuration indication states. The communications manager 920 may be configured as or otherwise support a means for transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The communications manager 920 may be configured as or otherwise support a means for receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, more efficient utilization of communication resources, or any combination thereof.

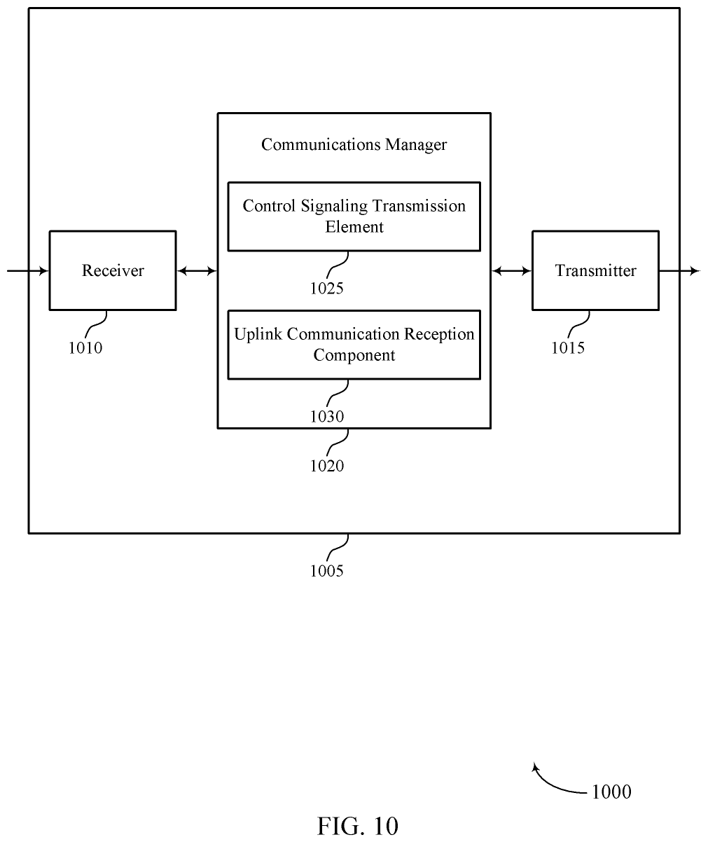

FIG. 10 shows a block diagram 1000 of a device 1005 that supports default power parameters per transmission and reception point in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of default power parameters per transmission and reception point as described herein. For example, the communications manager 1020 may include a control signaling transmission element 1025 an uplink communication reception component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The control signaling transmission element 1025 may be configured as or otherwise support a means for transmitting a first control message indicating a set of multiple code points and a set of multiple transmission configuration indication states. The control signaling transmission element 1025 may be configured as or otherwise support a means for transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The uplink communication reception component 1030 may be configured as or otherwise support a means for receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

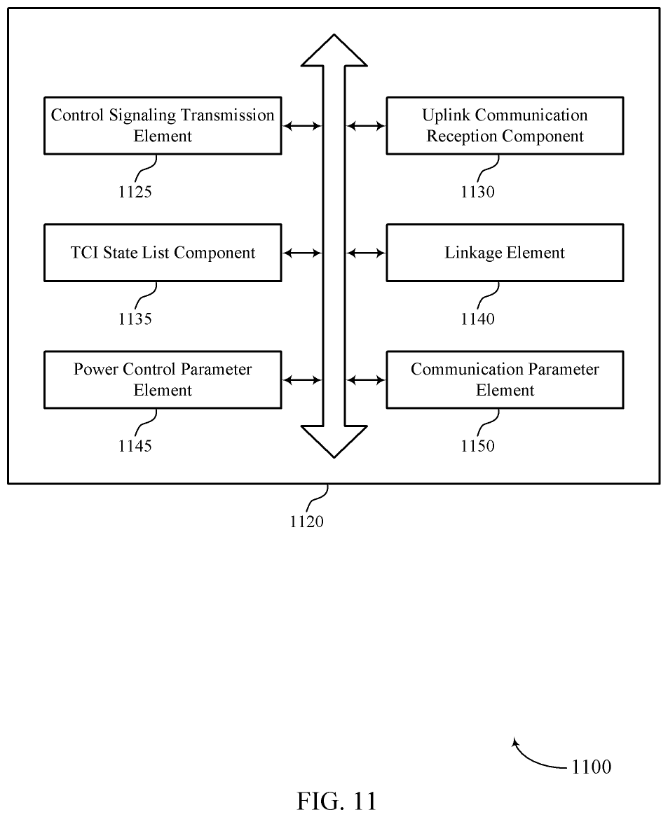

FIG. 11 shows a block diagram 1100 of a communications manager 1120 that supports default power parameters per transmission and reception point in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of default power parameters per transmission and reception point as described herein. For example, the communications manager 1120 may include a control signaling transmission element 1125, an uplink communication reception component 1130, a TCI state list component 1135, a linkage element 1140, a power control parameter element 1145, a communication parameter element 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The control signaling transmission element 1125 may be configured as or otherwise support a means for transmitting a first control message indicating a set of multiple code points and a set of multiple transmission configuration indication states. In some examples, the control signaling transmission element 1125 may be configured as or otherwise support a means for transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The uplink communication reception component 1130 may be configured as or otherwise support a means for receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

In some examples, the TCI state list component 1135 may be configured as or otherwise support a means for transmitting the control signaling indicating a transmission configuration indication state list corresponding to multiple transmission and reception point operation and the set of multiple power control parameters, where the transmission configuration indication state list includes the set of multiple transmission configuration indication states.

In some examples, the linkage element 1140 may be configured as or otherwise support a means for transmitting the control signaling, the first control message, or the second control message that indicates the linkage between the first transmission and reception point and the first set of power control parameters.

In some examples, the linkage element 1140 may be configured as or otherwise support a means for transmitting the control signaling that indicates the linkage between an identifier of the first set of power control parameters and the first transmission configuration indication state.

In some examples, the control signaling is radio resource control signaling.

In some examples, the linkage element 1140 may be configured as or otherwise support a means for transmitting the first control message that indicates the linkage between an identifier of the first set of power control parameters and the first transmission configuration indication state.

In some examples, the first control message includes a medium access control control element.

In some examples, the linkage element 1140 may be configured as or otherwise support a means for transmitting the second control message that indicates the linkage between an identifier of the first set of power control parameters and the first transmission configuration indication state.

In some examples, the second control message includes downlink control information.

In some examples, the first set of power control parameters and the first transmission configuration indication state are both associated with a communication parameter identifier.

In some examples, the communication parameter identifier includes an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

In some examples, an index associated with the first transmission configuration indication state and an index associated with the first set of power control parameters both include a common value.

In some examples, the power control parameter element 1145 may be configured as or otherwise support a means for selecting the set of multiple power control parameters based on a traffic type associated with the uplink communication.

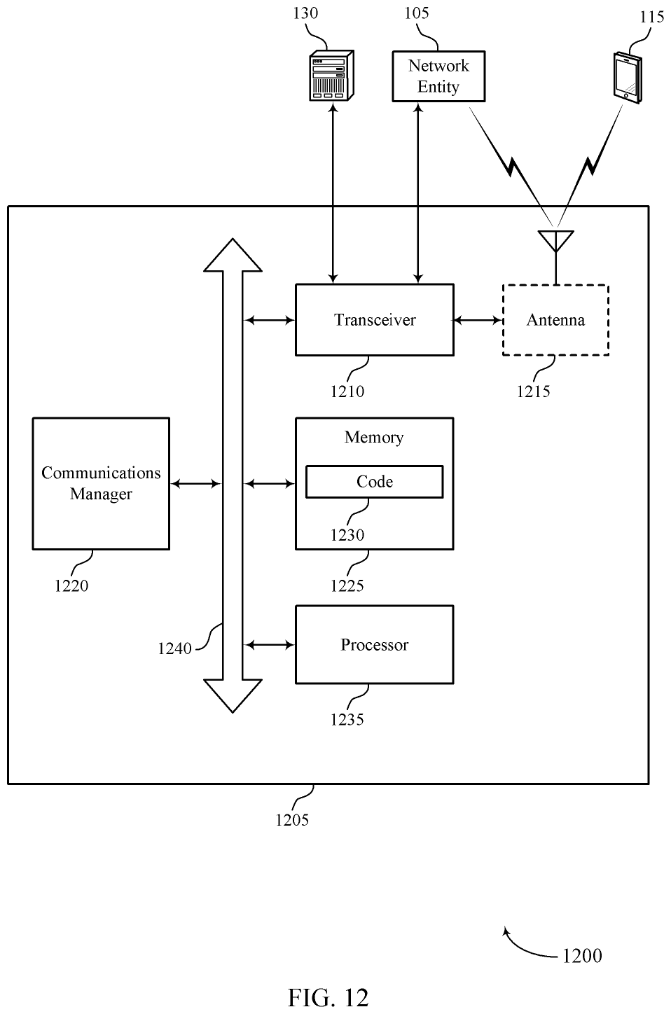

FIG. 12 shows a diagram of a system 1200 including a device 1205 that supports default power parameters per transmission and reception point in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting default power parameters per transmission and reception point). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a first control message indicating a set of multiple code points and a set of multiple transmission configuration indication states. The communications manager 1220 may be configured as or otherwise support a means for transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The communications manager 1220 may be configured as or otherwise support a means for receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. For example, the communications manager 1220 may be configured to receive or transmit messages or other signaling as described herein via the transceiver 1210. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of default power parameters per transmission and reception point as described herein, or the processor 1235 and the memory 1225 may be otherwise configured to perform or support such operations.

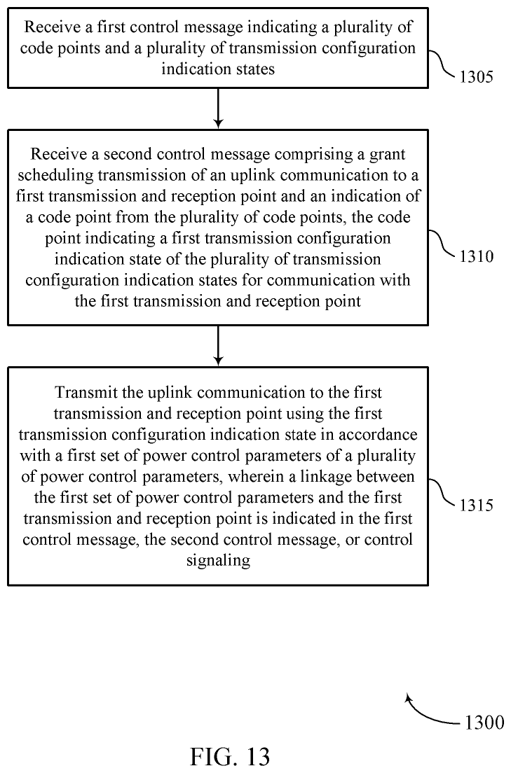

FIG. 13 shows a flowchart illustrating a method 1300 that supports default power parameters per transmission and reception point in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first control message indicating a set of multiple code points and a set of multiple transmission configuration indication states. The operations of 1305 may be performed in accordance with examples as disclosed herein. In some examples, aspects of the operations of 1305 may be performed by a control signaling reception component 725 as described with reference to FIG. 7. Additionally, or alternatively, means for performing 1305 may, but not necessarily, include, for example, antenna 825, transceiver 815, communications manager 820, memory 830 (including code 835), processor 840 and/or bus 845.

At 1310, the method may include receiving a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The operations of 1310 may be performed in accordance with examples as disclosed herein. In some examples, aspects of the operations of 1310 may be performed by a control signaling reception component 725 as described with reference to FIG. 7. Additionally, or alternatively, means for performing 1310 may, but not necessarily, include, for example, antenna 825, transceiver 815, communications manager 820, memory 830 (including code 835), processor 840 and/or bus 845.

At 1315, the method may include transmitting the uplink communication to the first transmission and reception point using the first transmission configuration indication state in accordance with a first set of power control parameters of a set of multiple power control parameters, where a linkage between the first set of power control parameters and the first transmission and reception point is indicated in the first control message, the second control message, or control signaling. The operations of 1315 may be performed in accordance with examples as disclosed herein. In some examples, aspects of the operations of 1315 may be performed by a power control parameter component 730 as described with reference to FIG. 7. Additionally, or alternatively, means for performing 1315 may, but not necessarily, include, for example, antenna 825, transceiver 815, communications manager 820, memory 830 (including code 835), processor 840 and/or bus 845.

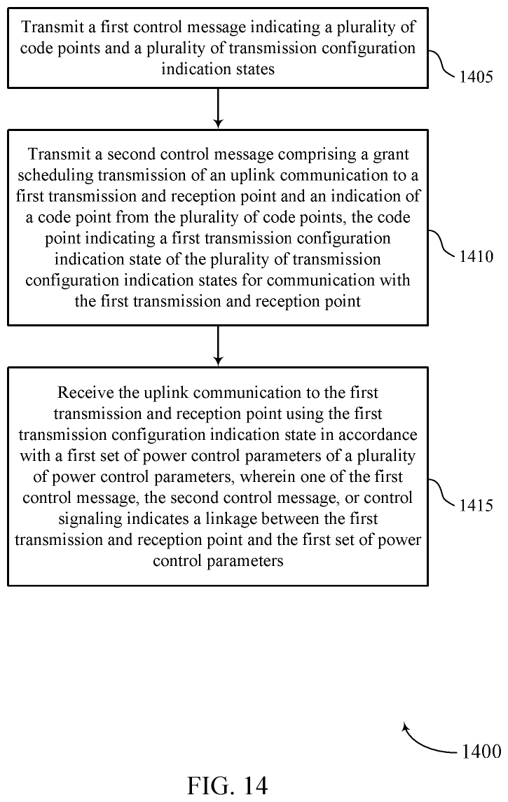

FIG. 14 shows a flowchart illustrating a method 1400 that supports default power parameters per transmission and reception point in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a first control message indicating a set of multiple code points and a set of multiple transmission configuration indication states. The operations of 1405 may be performed in accordance with examples as disclosed herein. In some examples, aspects of the operations of 1405 may be performed by a control signaling transmission element 1125 as described with reference to FIG. 11. Additionally, or alternatively, means for performing 1405 may, but not necessarily, include, for example, antenna 1215, transceiver 1210, communications manager 1220, memory 1225 (including code 1230), processor 1235 and/or bus 1240.

At 1410, the method may include transmitting a second control message including a grant scheduling transmission of an uplink communication to a first transmission and reception point and an indication of a code point from the set of multiple code points, the code point indicating a first transmission configuration indication state of the set of multiple transmission configuration indication states for communication with the first transmission and reception point. The operations of 1410 may be performed in accordance with examples as disclosed herein. In some examples, aspects of the operations of 1410 may be performed by a control signaling transmission element 1125 as described with reference to FIG. 11. Additionally, or alternatively, means for performing 1410 may, but not necessarily, include, for example, antenna 1215, transceiver 1210, communications manager 1220, memory 1225 (including code 1230), processor 1235 and/or bus 1240.

At 1415, the method may include receiving the uplink communication to the first transmission and reception point using the first transmission configuration indication state in accordance with a first set of power control parameters of a set of multiple power control parameters, where one of the first control message, the second control message, or control signaling indicates a linkage between the first transmission and reception point and the first set of power control parameters. The operations of 1415 may be performed in accordance with examples as disclosed herein. In some examples, aspects of the operations of 1415 may be performed by an uplink communication reception component 1130 as described with reference to FIG. 11. Additionally, or alternatively, means for performing 1415 may, but not necessarily, include, for example, antenna 1215, transceiver 1210, communications manager 1220, memory 1225 (including code 1230), processor 1235 and/or bus 1240.

The following provides an overview of aspects of the present disclosure:

Aspect 1: A method for wireless communications at a UE, comprising: receiving a first control message indicating a plurality of code points and a plurality of transmission configuration indication states; receiving a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and transmitting the uplink communication to the first transmission and reception point using the first transmission configuration indication state in accordance with a first set of power control parameters of a plurality of power control parameters, wherein a linkage between the first set of power control parameters and the first transmission and reception point is indicated in the first control message, the second control message, or control signaling.

Aspect 2: The method of aspect 1, further comprising: receiving the control signaling indicating a transmission configuration indication state list corresponding to multiple transmission and reception point operation and the plurality of power control parameters, wherein the transmission configuration indication state list comprises the plurality of transmission configuration indication states.

Aspect 3: The method of aspect 2, further comprising: processing the control signaling, the first control message, or the second control message that indicates the linkage between the first transmission and reception point and the first set of power control parameters.

Aspect 4: The method of any of aspects 2 through 3, further comprising: processing the control signaling that indicates the linkage between an identifier of the first set of power control parameters and the first transmission configuration indication state.

Aspect 5: The method of any of aspects 2 through 4, wherein the control signaling is radio resource control signaling.

Aspect 6: The method of any of aspects 1 through 5, further comprising: processing the first control message that indicates the linkage between an identifier of the first set of power control parameters and the first transmission configuration indication state.

Aspect 7: The method of aspect 6, wherein the first control message comprises a medium access control control element.

Aspect 8: The method of any of aspects 1 through 7, further comprising: processing the second control message that indicates the linkage between an identifier of the first set of power control parameters and the first transmission configuration indication state.

Aspect 9: The method of aspect 8, wherein the second control message comprises downlink control information.

Aspect 10: The method of any of aspects 1 through 9, further comprising: identifying that the first transmission configuration indication state and the first set of power control parameters are both associated with a communication parameter identifier.

Aspect 11: The method of aspect 10, wherein the communication parameter identifier comprises an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

Aspect 12: The method of any of aspects 1 through 11, further comprising: matching an index associated with the first transmission configuration indication state and an index associated with the first set of power control parameters wherein both indices comprise a common value.

Aspect 13: The method of any of aspects 1 through 12, wherein the plurality of power control parameters corresponds to a traffic type associated with the uplink communication.

Aspect 14: A method for wireless communications at a network entity, comprising: transmitting a first control message indicating a plurality of code points and a plurality of transmission configuration indication states; transmitting a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and receiving the uplink communication to the first transmission and reception point using the first transmission configuration indication state in accordance with a first set of power control parameters of a plurality of power control parameters, wherein one of the first control message, the second control message, or control signaling indicates a linkage between the first transmission and reception point and the first set of power control parameters.

Aspect 15: The method of aspect 14, further comprising: transmitting the control signaling indicating a transmission configuration indication state list corresponding to multiple transmission and reception point operation and the plurality of power control parameters, wherein the transmission configuration indication state list comprises the plurality of transmission configuration indication states.

Aspect 16: The method of aspect 15, further comprising: transmitting the control signaling, the first control message, or the second control message that indicates the linkage between the first transmission and reception point and the first set of power control parameters.

Aspect 17: The method of any of aspects 15 through 16, further comprising: transmitting the control signaling that indicates the linkage between an identifier of the first set of power control parameters and the first transmission configuration indication state.

Aspect 18: The method of any of aspects 15 through 17, wherein the control signaling is radio resource control signaling.

Aspect 19: The method of any of aspects 14 through 18, further comprising: transmitting the first control message that indicates the linkage between an identifier of the first set of power control parameters and the first transmission configuration indication state.

Aspect 20: The method of aspect 19, wherein the first control message comprises a medium access control control element.

Aspect 21: The method of any of aspects 14 through 20, further comprising: transmitting the second control message that indicates the linkage between an identifier of the first set of power control parameters and the first transmission configuration indication state.

Aspect 22: The method of aspect 21, wherein the second control message comprises downlink control information.

Aspect 23: The method of any of aspects 14 through 22, wherein the first set of power control parameters and the first transmission configuration indication state are both associated with a communication parameter identifier.

Aspect 24: The method of aspect 23, wherein the communication parameter identifier comprises an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

Aspect 25: The method of any of aspects 14 through 24, wherein an index associated with the first transmission configuration indication state oand an index associated with the first set of power control parameters both comprise a common value.

Aspect 26: The method of any of aspects 14 through 25, further comprising: selecting the plurality of power control parameters based at least in part on a traffic type associated with the uplink communication.

Aspect 27: An apparatus comprising a memory, transceiver, and at least one processor of a user equipment (UE) coupled with the memory and the transceiver, the at least one processor configured to cause the apparatus to perform a method of any of aspects 1 through 13.

Aspect 28: An apparatus for wireless communications at a UE, comprising at least one means for performing a method of any of aspects 1 through 13.

Aspect 29: A non-transitory computer-readable medium storing code for wireless communications at a UE, the code comprising instructions executable by a processor to perform a method of any of aspects 1 through 13.

Aspect 30: An apparatus comprising a memory, transceiver, and at least one processor of a network entity coupled with the memory and the transceiver, the at least one processor configured to cause the apparatus to perform a method of any of aspects 14 through 26.

Aspect 31: An apparatus for wireless communications at a network entity, comprising at least one means for performing a method of any of aspects 14 through 26.

Aspect 32: A non-transitory computer-readable medium storing code for wireless communications at a network entity, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first control message indicating a plurality of code points and a plurality of transmission configuration indication states;
receiving a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and
transmitting the uplink communication to the first transmission and reception point using the first transmission configuration indication state in accordance with a first set of power control parameters of a plurality of power control parameters, wherein a linkage between the first set of power control parameters and the first transmission and reception point is indicated in the first control message, the second control message, or control signaling.

2. The method of claim 1, further comprising:
receiving the control signaling indicating a transmission configuration indication state list corresponding to multiple transmission and reception point operation and the plurality of power control parameters, wherein the transmission configuration indication state list comprises the plurality of transmission configuration indication states.

3. The method of claim 2, further comprising:
processing the control signaling, the first control message, or the second control message that indicates the linkage between the first transmission and reception point and the first set of power control parameters.

4. The method of claim 2, further comprising:
processing the control signaling that indicates the linkage between an identifier of the first set of power control parameters and the first transmission configuration indication state.

5. The method of claim 2, wherein the control signaling is radio resource control signaling.

6. The method of claim 1, further comprising:
processing the first control message that indicates the linkage between an identifier of the first set of power control parameters and the first transmission configuration indication state.

7. The method of claim 6, wherein the first control message comprises a medium access control control element.

8. The method of claim 1, further comprising:
processing the second control message that indicates the linkage between an identifier of the first set of power control parameters and the first transmission configuration indication state.

9. The method of claim 8, wherein the second control message comprises downlink control information.

10. The method of claim 1, further comprising:
identifying that the first transmission configuration indication state and the first set of power control parameters are both associated with a communication parameter identifier.

11. The method of claim 10, wherein the communication parameter identifier comprises an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

12. The method of claim 1, further comprising:
matching an index associated with the first transmission configuration indication state and an index associated with the first set of power control parameters wherein both indices comprise a common value.

13. The method of claim 1, wherein the plurality of power control parameters corresponds to a traffic type associated with the uplink communication.

14. A method for wireless communications at a network entity, comprising:
transmitting a first control message indicating a plurality of code points and a plurality of transmission configuration indication states:
transmitting a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and
receiving the uplink communication to the first transmission and reception point using the first transmission configuration indication state in accordance with a first set of power control parameters of a plurality of power control parameters, wherein one of the first control message, the second control message, or control signaling indicates a linkage between the first transmission and reception point and the first set of power control parameters.

15. The method of claim 14, further comprising:
transmitting the control signaling indicating a transmission configuration indication state list corresponding to multiple transmission and reception point operation and the plurality of power control parameters, wherein the transmission configuration indication state list comprises the plurality of transmission configuration indication states.

16. The method of claim 15, further comprising:
transmitting the control signaling, the first control message, or the second control message that indicates the linkage between the first transmission and reception point and the first set of power control parameters.

17. The method of claim 15, further comprising:
transmitting the control signaling that indicates the linkage between an identifier of the first set of power control parameters and the first transmission configuration indication state.

18. The method of claim 15, wherein the control signaling is radio resource control signaling.

19. The method of claim 14, further comprising:
transmitting the first control message that indicates the linkage between an identifier of the first set of power control parameters and the first transmission configuration indication state.

20. The method of claim 19, wherein the first control message comprises a medium access control control element.

21. The method of claim 14, further comprising:
transmitting the second control message that indicates the linkage between an identifier of the first set of power control parameters and the first transmission configuration indication state.

22. The method of claim 21, wherein the second control message comprises downlink control information.

23. The method of claim 14, wherein the first set of power control parameters and the first transmission configuration indication state are both associated with a communication parameter identifier.

24. The method of claim 23, wherein the communication parameter identifier comprises an identifier associated with the first transmission and reception point, a control resource set pool index, a transmission configuration indication identifier, a beam group identifier, a channel identifier, a reference signal identifier, a resource group identifier, a send routing information field order index, a sounding reference signal resource set identifier, a sounding reference signal resource set order index, a default power control parameter identifier, or any combination thereof.

25. The method of claim 14, wherein an index associated with the first transmission configuration indication state and an index associated with the first set of power control parameters both comprise a common value.

26. The method of claim 14, further comprising:
selecting the plurality of power control parameters based at least in part on a traffic type associated with the uplink communication.

27. An apparatus for wireless communications, comprising:
memory:
a transceiver; and
at least one processor of a user equipment (UE), the at least one processor coupled with the memory and the transceiver, and the at least one processor configured to cause the apparatus to:
receive, via the transceiver, a first control message indicating a plurality of code points and a plurality of transmission configuration indication states:
receive, via the transceiver, a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and
transmit, via the transceiver, the uplink communication to the first transmission and reception point using the first transmission configuration indication state in accordance with a first set of power control parameters of a plurality of power control parameters, wherein a linkage between the first set of power control parameters and the first transmission and reception point is indicated in the first control message, the second control message, or control signaling.

28. The apparatus of claim 27, the at least one processor further configured to cause the apparatus to:
receive the control signaling indicating a transmission configuration indication state list corresponding to multiple transmission and reception point operation and the plurality of power control parameters, wherein the transmission configuration indication state list comprises the plurality of transmission configuration indication states.

29. An apparatus for wireless communications, comprising:
memory:
a transceiver; and
at least one processor of a network entity, the at least one processor coupled with the memory and the transceiver, and the at least one processor configured to cause the apparatus to:
transmit, via the transceiver, a first control message indicating a plurality of code points and a plurality of transmission configuration indication states:
transmit, via the transceiver, a second control message comprising a grant scheduling transmission of an uplink communication to a first transmission and reception point and an indication of a code point from the plurality of code points, the code point indicating a first transmission configuration indication state of the plurality of transmission configuration indication states for communication with the first transmission and reception point; and
receive, via the transceiver, the uplink communication to the first transmission and reception point using the first transmission configuration indication state in accordance with a first set of power control parameters of a plurality of power control parameters, wherein one of the first control message, the second control message, or control signaling indicates a linkage between the first transmission and reception point and the first set of power control parameters.

30. The apparatus of claim 29, the at least one processor further configured to cause the apparatus to:
transmit the control signaling indicating a transmission configuration indication state list corresponding to multiple transmission and reception point operation and the plurality of power control parameters, wherein the transmission configuration indication state list comprises the plurality of transmission configuration indication states.
